(19) United States
(12) Patent Application Publication
(10) Pub. No.: US 2016/0138703 A1
(43) Pub. Date: May 19, 2016

(54) Tool for the Application and Dispensing of Lubricants, Cleaners and Dressings to Chains, Cables, Ropes and Lines Having an External Brush

(71) Applicant: PATRICK R. DORAN, LYNWWOD, WA (US)

(72) Inventor: PATRICK R. DORAN, LYNWWOD, WA (US)

(21) Appl. No.: 14/956,183

(22) Filed: Dec. 1, 2015

Related U.S. Application Data
(63) Continuation-in-part of application No. 13/563,364, filed on Jul. 31, 2012.
(60) Provisional application No. 61/514,453, filed on Aug. 2, 2011.
(60) Provisional application No. 62/086,131, filed on Dec. 1, 2014.

(51) Int. Cl. F16H 57/05; F16H 57/04

(52) U.S. Cl. CPC F16H 57/05; F16H 57/0436

(57) ABSTRACT

A system for applying lubricants, dressings, and the like to long objects such as drive chains, cables, ropes and the like. The system includes the material to be applied and a multipurpose tool including an external brush assembly to aid in the dispersal of lubricants, or the like, and to aid in cleaning. The multipurpose tool is a chambered device designed for the primary function of directing and applying lubrication, and other dressings, onto chains, cables, belts, ropes and lines. The tool includes an enclosure that can be opened by hand and closed like a ‘clamshell’ using an integral hinge and a locking closure mechanism, to encompass the work pieces, creating a chamber for application of liquid and aerosol lubricants, cleaning agents and other dressing materials onto the entire length of the long objects as they pass through the tool.

### CROSS-REFERENCE TO RELATED APPLICATION

This application is a continuation-in-part of application Ser. No. 13/563,364, filed Jul. 31, 2012, which claims the benefit of U.S. Provisional Patent Application No. 61/514,453 filed Aug. 2, 2011 the subject matter of which is incorporated herein by reference. This application also claims the benefit of U.S. Provisional Patent Application No. 62/068,131 filed Dec. 1, 2014, the contents of which are hereby incorporated by reference.

### TECHNICAL FIELD

This description relates generally to hand tools and more specifically to tools for applying a substance such as a lubricant, or the like, to a part or component, and include a brush attachment.

### BACKGROUND

Long objects with thin profiles such as cables, ropes, chains and the like are often lubricated. A typical example is a bicycle, or motorcycle chain that is lubricated to prevent wear as it is used to transmit power from the engine to the rear wheel. Lubrication is often achieved by squeezing lubricant from a container onto the chain as it is passed over the opening in the lubricant container. This type of process often results in drops of lubricant dripping to the floor, or excessive amounts of fluid that are thrown off of the chain onto a rider or onto the motorcycle or bicycle. Lubrication may also be conveniently provided in spray containers. The chain is sprayed as it is passed before the nozzle of the spray container. This type of application may also lead to dripping, and uneven application of the lubricant. In addition the spray tends to have a wide pattern, so that a large portion of any spray stream often misses the chain, and over sprays onto adjacent objects such as the frame of the bicycle or motorcycle, or out and onto the floor. It would be desirable to have a system of applying lubricants and dressings to such long thin objects that guides application of the material onto the desired part, while preventing overspray, dripping and waste of materials.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a system for applying lubricants, dressings, and the like to long objects such as drive chains, cables, ropes and the like. The system includes the material to be applied and a multipurpose tool. The multipurpose tool is a chambered device forming a shield or housing, designed for the primary function of directing and applying lubrication, cleaning agents liquids and aerosols and other dressings, onto chains, cables, belts, ropes and lines. Application is achieved by an articulating top horizontal section of the enclosure that can be opened by hand and closed like a ‘clamshell’ using an integral hinge and a locking closure mechanism, to encompass the components or work pieces, and allow the tool to be advantageously placed upon the work piece, in such a way that the chain, cable, belt, rope or line, will pass through an opening in the end walls of the tool without obstruction; thereby, creating a constrained chamber-like environment within the interior of the tool that provides facilities for clean application and dispersal of liquid and aerosol lubricants, cleaning agents and other dressing materials onto the entire length of bearing and articulating surfaces of these component devices as they are passed through the tool. The tool advantageously includes a brush or wiper at the work piece exit to facilitate additional fluid distribution, and cleaning of the work piece. The physical dimensions of the tool can be optimally fabricated to be of relative size and dimension, so the tool can easily encompass any size of chain, cable, belt, rope or line component device of a parent mechanism.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates the lubrication or dressing system in use.

FIG. 2 illustrates a cut-away view from the front of the tool body showing how a component may receive dressing or lubrication as it passes through the tool.

FIG. 3 illustrates a cut-away view from the front of the tool body showing the interior and exterior details of the tool.

FIG. 4 illustrates the tool in opened and closed positions with two side-views of the tool body where the first view 400 shows the tool closed and fastened around a component, and the second view 402 depicts what the tool may look when opened for installation or removal of the component.

FIG. 5 shows is an end view showing the interior of the tool.

FIG. 6 shows a side view of an alternative example of the tool having a circular body shape as viewed from the side or end.

FIG. 7 illustrates the syringe pump delivery mechanism 113 for dressings or lubricants to the tool.

FIG. 8 illustrates an aerosol spray delivery mechanism for dressings or lubricants to the tool.

FIG. 9 is a process flow diagram showing construction of the tool.

FIG. 10 shows a front view of an alternative example of the invention.

FIG. 11 shows a cut away side view of the alternative example of the invention.

FIG. 12 shows a cut away end view of the alternative example of the invention.

FIG. 13 shows a brush/wiper attachment coupled to the tool.

FIG. 14 show san example of a brush/wiper.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a system for lubricating a long object such as an exemplary drive chain, cable, rope, rod and the like. Although the present examples are described and illustrated herein as being implemented in a drive-chain system, the system described is provided as an example and not a limitation. As those skilled in the art will appreciate, the present examples are suitable for application in a variety of different types of lubrication or dressing application systems, such as those for lubricating chains, cables ropes rods and the like.

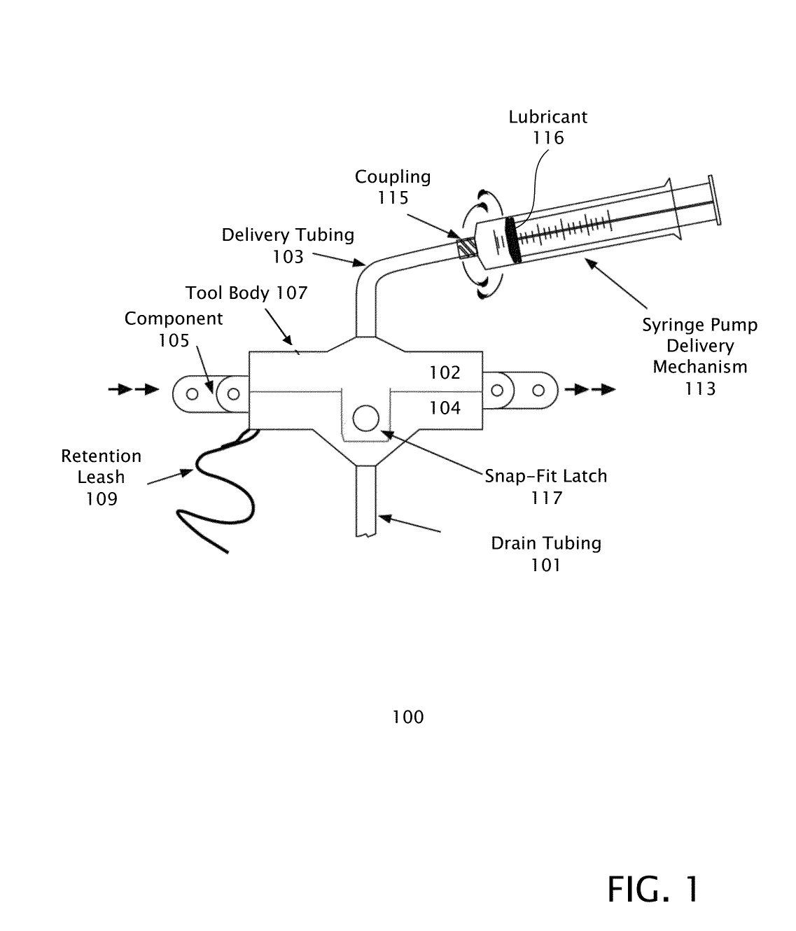

FIG. 1 illustrates the lubrication or dressing system in use. The figure shows the tool body 107 as it may be installed over a component 105 (depicted here as a chain but not limited to). The tool further includes the snap-fit latch, or their equivalent 117 (that may include a conventionally constructed locking or securement mechanism), delivery tubing segment 103, drain tubing 101, a syringe pump delivery mechanism 113, or other equivalent dressing or lubrication container shown here having an exemplary integral luer-locking coupler 115, and a retention leash 109. Alternatively an arm, extension or other equivalent structure can be provided to hold the tool body 107 somewhat stationary.

The multipurpose tool 100 may be shaped like a clam shell, and is designed for directing and applying lubrication, cleaning agents liquids and aerosols other dressings and the like (lubricant or lubricants) 116, onto chains, cables, belts, ropes, lines and the like (component or components) 105 without the usual amount of overspray, waste, and mess. This may be achieved by providing an opening top horizontal section of the tool 102 that can be opened and closed like a ‘clamshell’ to a bottom section 104, by an integral hinge (not shown, on the reverse side) and a latching mechanism 117, so to encompass these types of components 105 and allow the tool body 107 to be disposed about these components 105, in such a way that the chain, cable, belt, rope or line, will pass through the open ends of the horizontal segment of the tool without obstruction; thereby, creating a constrained chamber-like environment within the interior of the tool that provides facilities for clean application of liquid and aerosol lubricants, cleaning agents and other dressing materials onto the entire length of these component devices 105 as they pass through the tool body 107. The physical dimensions of the tool can be of various sizes for a given application, so the tool can easily encompass any size of chain, cable, belt, rope or line without typically having to remove it.

The tool body 107 is versatile and may be configured for use with a number of dressings, and lubricants. The tool body 107 incorporates an integral internal portal(s) (not shown) for the flow and application of liquids and aerosols of all sorts. The internal portals can include orifices which may be coupled, by flexible plastic tubing conduits, or their equivalents, to deliver and direct the liquid materials into the interior of the device. The portal orifices employs removable plastic tubing sections that deliver liquids and aerosols using simple slip-fit attachment points or their equivalent disposed on the tool body 107 over which the tubing 103 (delivery), 101 (drain) fits. Alternatively any other equivalent coupling of the tubing 103, 101 to the body 107 may be provided.

Associated to the fluid delivery tubing 103, the tool design incorporates a multifunction interface coupling 115 on the exposed end of the material delivery tubing 103 to facilitate the attachment/coupling of a syringe pump delivery mechanism 113, which may be used to deploy non-aerosol lubrication fluids, cleaning agents and other dressings. Also, this interface port can accept small diameter nozzle extension tubes commonly found with aerosol spray-can dispensed products of this nature, or any other product that can employ these small diameter extension tubes.

The lower segment of the “clamshell”, 104 may incorporate or form an integral ‘sump’ drain. The dimensions of the sump drain, allow for the efficient collection and flow of excess material present from the lubrication, cleaning or dressing process. Excess flows from the interior lubrication chamber down through the drain portal (not shown), into the removable drain tubing segment 101 for containment, disposal and/or recycling of these materials. Alternatively the drain portal may be absent or plugged, so that the fluid is collected in the sump, and may be disposed of later.

The tool body 107 may be provided with a restraining leash 109 coupled to the tool body 107, which when attached to an anchor point, maintains the tool at a desired position upon the component chain, cable, belt, rope or line 105, as the chain, cable, belt, rope, line or the like 105 passes through the tool body 107. The leash 109 may provide secure and stable positioning and access to the tool, thus preventing it from being pulled into other parts of the parent mechanism by frictional forces and causing damage to the tool and/or the parent mechanism in general. The leash 109 may be fabricated from string, chain, or any suitable material.

Once the tool is simply opened by hand and then subsequently closed securely by the convenience of the flexible hinge and snap-fit closure mechanism 117 and then strategically positioned and constrained by the leash 109 upon and around the chain, cable, belt, rope or line component 105, the unique clamshell design creates a shielded lubrication chamber. The design also allows for optimized positioning of the tool body 107, so components 105 can travel through the opened ends of the chamber formed by the body 107, without obstruction or interference, thereby allowing clean, rapid, controlled dispensing and dispersement of lubricants, cleaning agents or other dressing fluids, into the chamber. Application of dressings or lubricants to the component 105 may be aided by way of the delivery tubing 103, from which an internal portal orifice nozzle (not shown) and the applicator/brushes, disperse the fluid onto and over the entire length of the component bearing and articulating surfaces as they pass through the tool.

The unique multifunction attachment port or coupling 115 on the delivery tubing 103, provides convenient attachment of the syringe pump delivery mechanism 113, so the tool user can easily dispense and apply, readily available and inexpensive bulk source lubrication products and convenient use of readily available, aerosol spray-can products and dressings.

The syringe pump delivery mechanism 113 provides controlled and continuous flow of bulk lubrication fluids into the interior chamber of the tool without overflow. The syringe may be obtained pre-loaded, or may be loaded by the user with any desired lubricant or dressing.

The integration of the tool body design having an internal orifice ‘nozzle’ and the functional shape of the tool body 107 provide a means to efficiently direct aerosol spray materials into the interior chamber of the tool without over-spray and the integral drain portal ‘sump’ serves as a guide, to redirect liquid any material overflow towards the evacuation or drain portal orifice disposed in the tool where the drain tubing 101 couples to the tool. This provides an effective and efficient containment of excess lubrication and cleaning byproducts, for recycling or reuse, by way of the evacuation drain tubing 101.

The unique design of the slip-fit connections coupling the tubing sections 101, 103 to the tool 100 and integrated into the body of the tool 107, allow for quick and simple attachment and detachment of varying lengths of tubing 101, 103, so the length of tubing can be optimized by the tool user to customize the deployment of the tool 100 on a particular machine mechanism for ease of use and for subsequent cleaning or replacement of tubing and storage of the tool, etcetera.

The tool construction serves as a mechanism for clean and extremely efficient application of readily available lubrication fluids, sprays; cleaning agent fluids, sprays and other dressings onto chain, cable, belt, rope, or line component bearing and articulating surfaces by reducing the amount of material used or required to accomplish the task of lubrication or cleaning. The containment and elimination of overspray or overflow material produced by the application and dispersal processes provided by the unique shield design, the multifunction interface port and the strategic placement of applicator/brushes/dams internal and integral to the tool body 107, all serve to simultaneously prevent contamination by overflowed or over-sprayed materials onto surrounding parent mechanism component surfaces, such as a bicycle or motorcycle wheel and tire, or any other part of a parent mechanism of which the chain, cable, belt, rope or line component is employed, where normally, this overflow or overspray will present hazardous conditions, visible degradation of aesthetics and other undesirable effects.

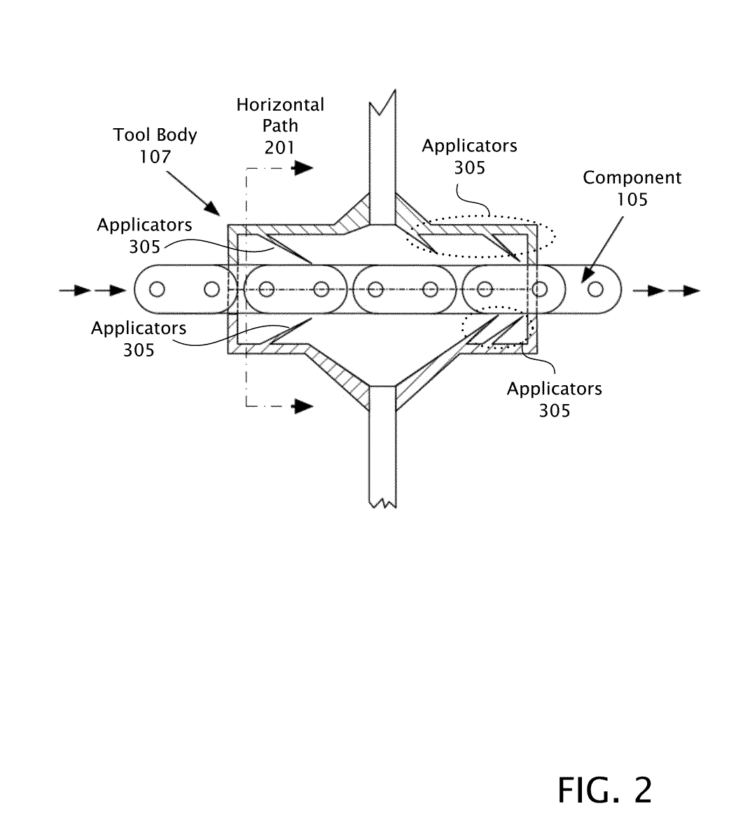

FIG. 2 illustrates a cut-away view from the front of the tool body including a component, and showing how the component may receive dressing or lubrication as it passes through the tool. The cut-away view of the tool body 107 along the horizontal path 201, shows how a component 105 may travel through the tool and the direction of flow through the tool openings at each end. Also shown are applicators 305, that may be provided to guide or apply lubricant or dressing onto the component 105.

The applicators 305 may be pads wipers or the like that tend to help disperse fluid onto the chain or work piece as it passes over the applicators, and to restrict outflow of the lubricant from the ends. Typically the applicators are constructed to contact the work piece as it passes over them. In the example shown the applicators 305 are constructed from the same material as the body 107, and formed at the same time as the body as a single piece. Such a construction is economical as the number of pieces are reduced. The material selected for the body and applicators is chosen to have sufficient rigidity to maintain its shape, but provide some flexibility as may be needed for the applicators to function properly without excessive wear from contact with a moving part being lubricated. Alternatively, the applicators may be constructed from high density polyethylene (HDPE), felt, rubber or the like. They may also, in alternative examples, be removabally coupled to the tool body so that they can be replaced if desired.

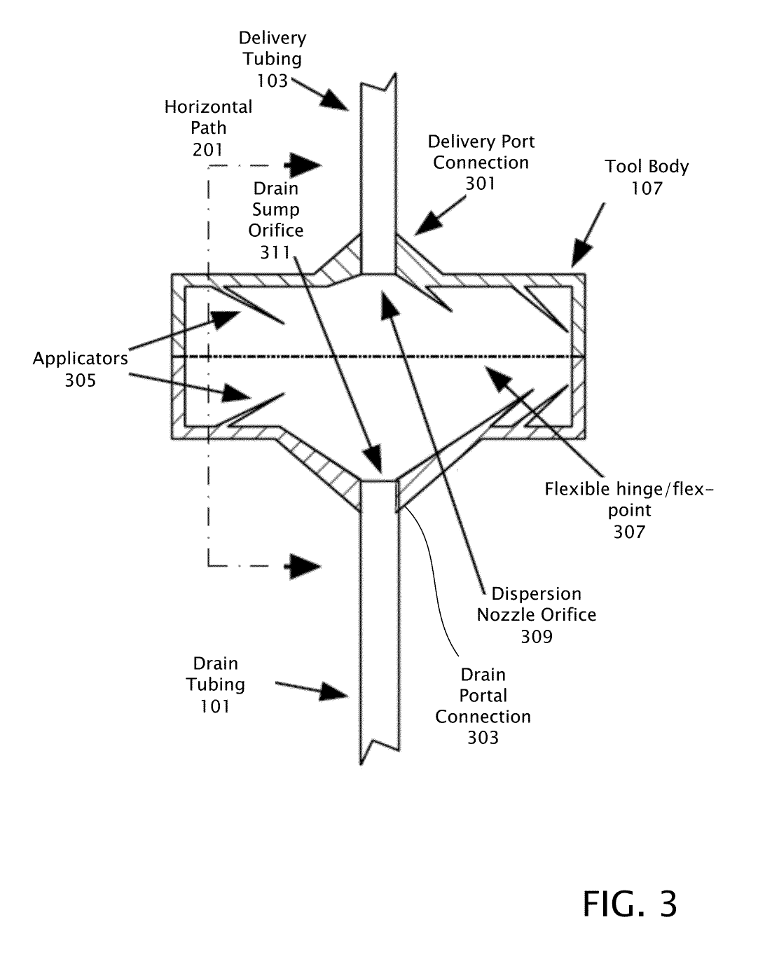

FIG. 3 illustrates a cut-away view from the front of the tool body without a component (105 of FIG. 1) present. This view shows further details of the tool interior. The cut-away view of the tool body 107 is along the horizontal path 201, showing the interior and exterior detail such as the protruding applicators, brushes, dams, or the like 305. Also shown is the delivery port connection 301 with the delivery tubing 103 inserted. The dispersion nozzle orifice 309 and drain port connection 303 with the drain tubing 101 inserted, the drain sump orifice 311 and the flexible resilient hinge 307 as seen from this sectional view of the tool body interior are also shown. The flexible hinge 307 may be constructed as an actual hinge or as also used constructed as a flex point, or flexation line that acts as a hinge due to a reduced amount of material along a line that allows the tool to flex along the line so that it can be opened.

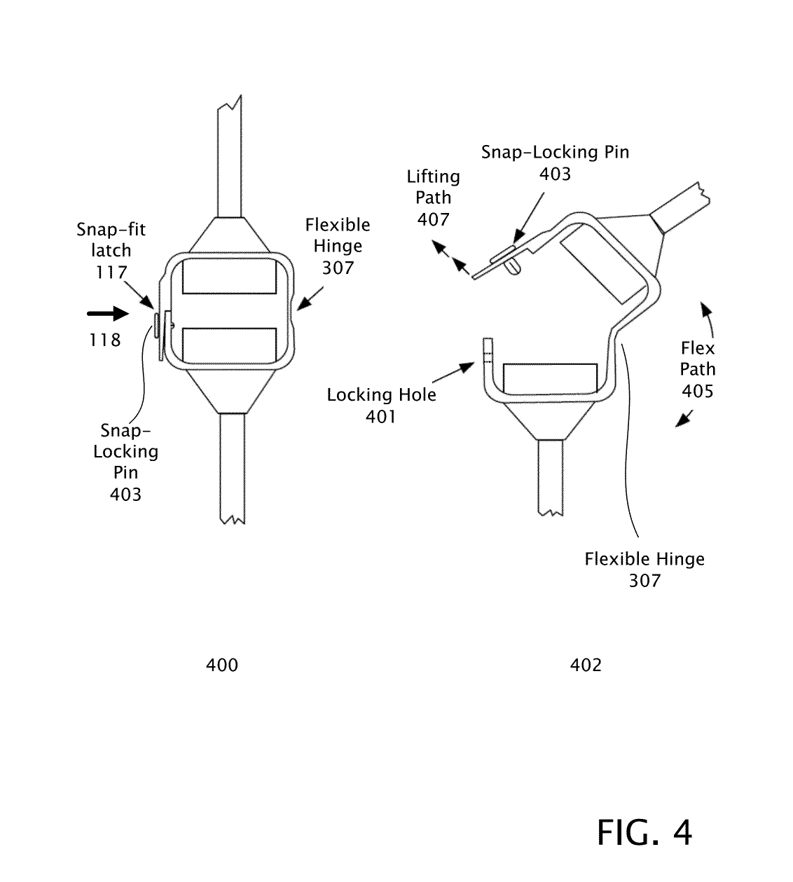

FIG. 4 illustrates the tool in opened and closed positions with two side-views of the tool body where the first view 400 shows the tool closed and fastened around a component, and the second view 402 depicts what the tool may look when opened for installation or removal of the component. The first view 400 is the tool when it is installed, closed and locked around a component, whereby applying pressure in the direction 118 will insert the snap-locking pin 403, which is integral to or inserted into the latch flap 117 into the locking hole 401. In an alternative example a magnetic latch may be used instead of the previously described latch. In the magnetic latch a magnet may be disposed in the body (or flap), with a ferromagnetic material disposed in the flap (or body) so that when the lid is closed the ferromagnetic material is attracted to the magnet, keeping the case secured. The second view 402 depicts what the tool may look when the tool is opened for installation or removal from the component by applying a lifting motion to the latch flap in an upward direction 407 so to separate the clam-shell body halves and shows how the flexible hinge 307 may flex along a path 405 when opened.

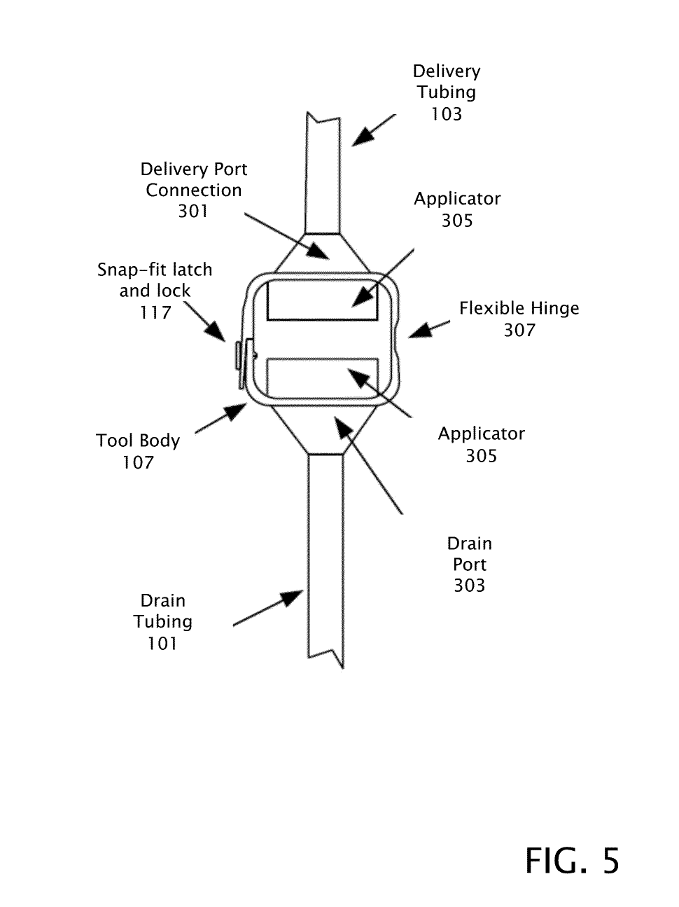

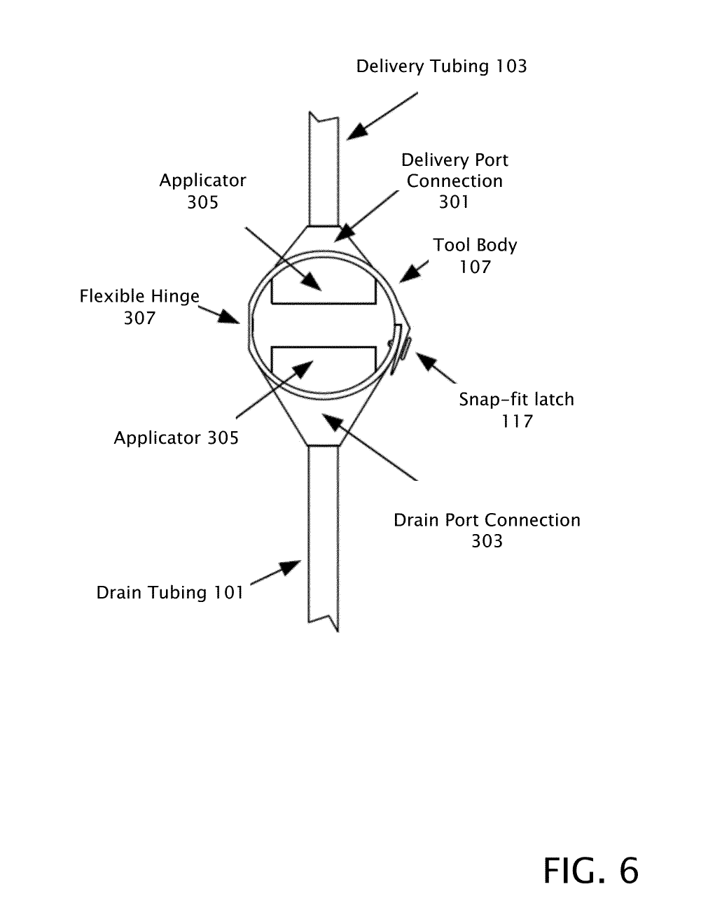

FIGS. 5 and 6 show alternate side-views of the tool body 107 as it may be alternatively manufactured. The first view in FIG. 5 shows a rectangular body shape. The second side view in FIG. 6 shows a more rounded or circular body shape. Alternatively the body can be formed into a variety of equivalent shapes that are capable of functioning to contain the lubricant and direct its application to the part as described herein.

FIG. 5 shows the interior of the tool as viewed from the side or end. Also depicted are alternate side-views of features and features such as applicators, brushes, dams, or the like 305, delivery port connection 301, delivery tubing segment 103, drain port connection 303, drain tubing 101, snap-fit latch 117, flexible hinge 307 as these may appear on different forms of the tool, but not limited to these means or forms.

FIG. 6 shows a side view of an alternative example of the tool having a circular body shape as viewed from the side or end. The components are as previously described in FIG. 5. However, this example has a body 107 with less sharp angles that may tend to help in injection molding when forming the part.

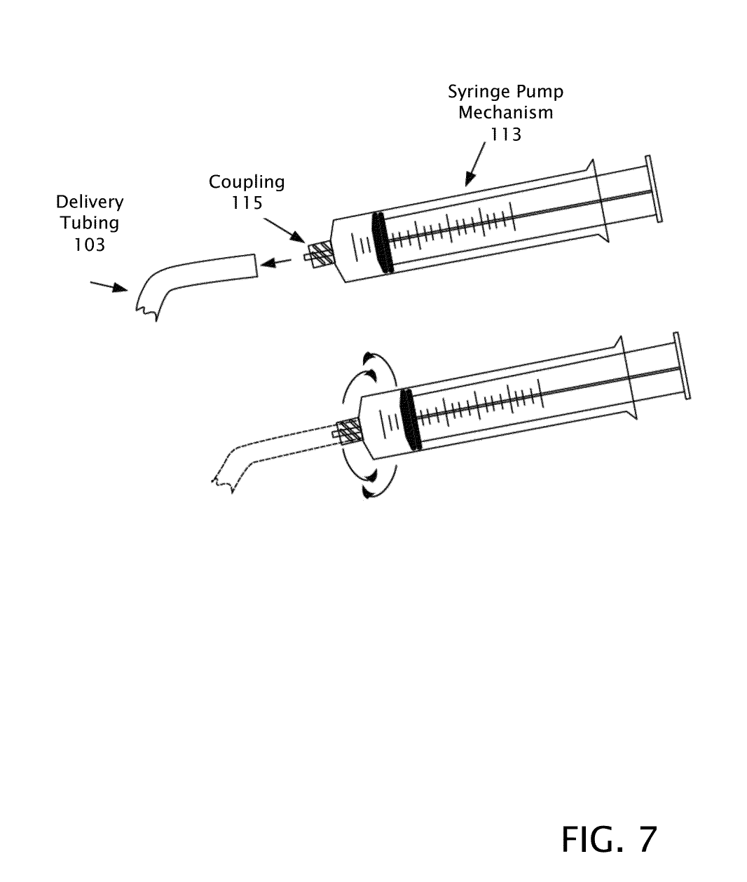

FIG. 7 illustrates the syringe pump delivery mechanism 113 for dressings or lubricants to the tool. The syringe pump delivery mechanism 113 may be attached to the delivery tubing 103 by twisting the syringe body onto and off of the delivery-tubing by use of the luer-locking coupler 115 of the syringe delivery mechanism.

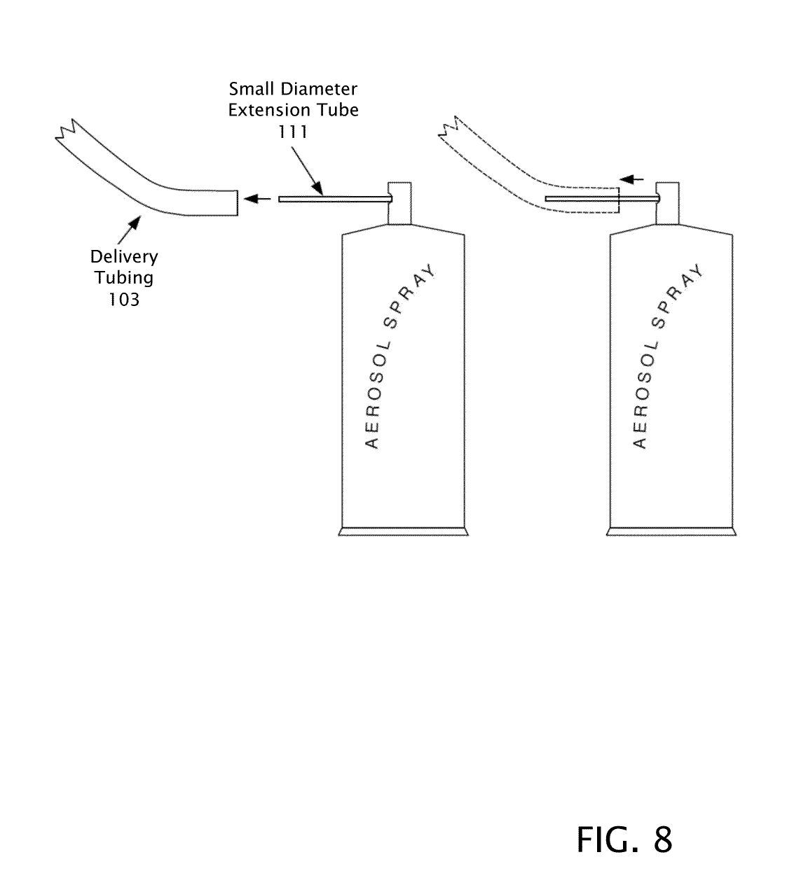

FIG. 8 illustrates an aerosol spray delivery mechanism for dressings or lubricants to the tool. The figure illustrates how the attachment point on the end of the delivery tubing 103 can accept the small diameter extension tube 111 commonly found with aerosol spray delivery systems.

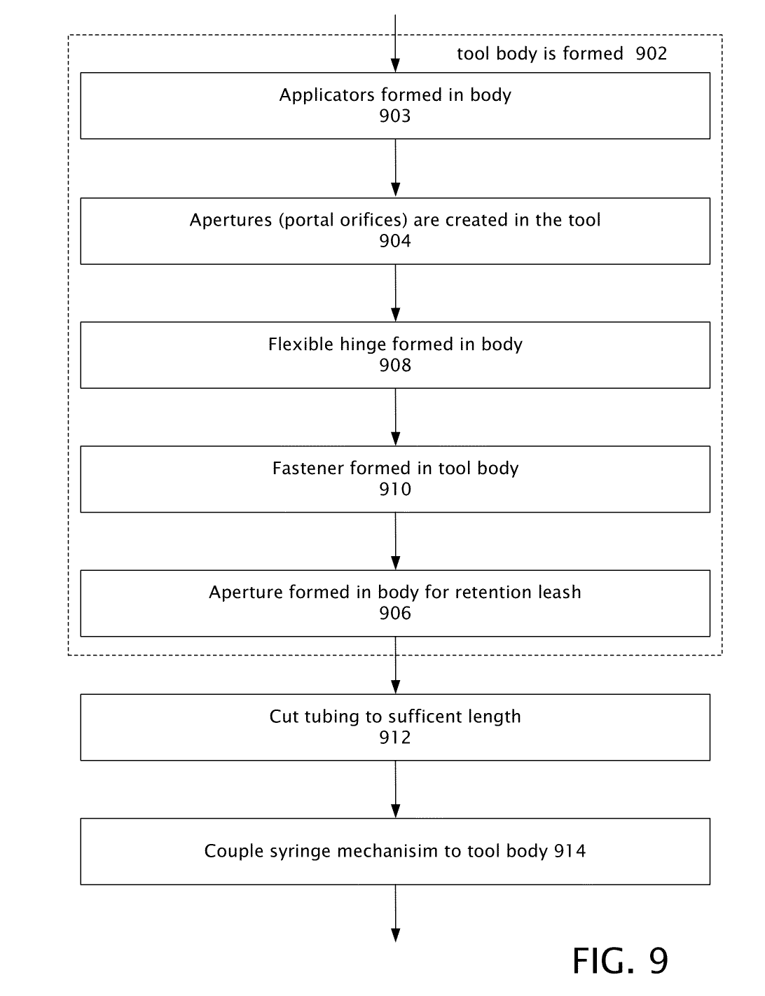

FIG. 9 is a process flow diagram showing construction of the tool. The tool body is typically formed or fabricated 902 by injection molding or casting of solvent resistant material that creates a tool body that may be rigid enough to maintain the primary “clamshell” design. In addition the shell formed supports the fluid delivery portal and the drain portal couplers, integral applicators, brushes, or dams and an integral flex-point/hinge and a flap-like closure that provides for a snap-fit locking device or it's equivalent. An exemplary material for the tool body is high density polyethylene (HDPE) or its equivalent.

Apertures (portal orifices) are created in the tool 904 at strategic locations so to enable fluid entry into the interior of the tool and to enable excess fluid evacuation facilities by way of the flexible tubing conduit segments, which includes the insertion of the material delivery tube, the drain tube segments and a hole or other suitable aperture for the attachment of the retention/stabilization leash 906. Alternatively an arm structure may be formed as previously described.

By the utilization of an injection molding or casting processes, an integrated ‘body’ may be created. The integrated features of this mold provide for the realization of a structure that allows for articulation at a specific ‘flex-point or hinge’ that is integral to the body of the tool 908 and is of same material composition, or alternatively of a combination of materials. For example fusing another material such as butyl rubber or silicone to the body may alternatively form the hinge. Alternatively the hinge may be dispensed with and the case may be in two pieces that are coupled together by any convenient mechanism. This ‘flex-point or equivalent hinge’ is realized by reducing the amount of material at this point, in such a way to provide suppleness, flexibility, and spring in the material so that the body of the tool can open and close in a “clam shell” manner by bending, deforming, or otherwise deflecting while at the same time holding the integral structure of the tool section/halves together, so the ‘flex-point or hinge’ mechanism can provide durable resilient ‘spring-like’ opening and closure action in order facilitate the sealed, secure attachment around the component chain, cable, belt, rope or line component, thereby creating a constrained and shielded lubrication chamber environment that will encompass the circumference of the component surfaces.

This molding or casting process also includes the ‘flap, or tab-like’ locking latch closure mechanism 910 that incorporates a ‘snap-fit’ lock that holds and secures the two articulating ‘clam shell’ sections of the tool together so to create the lubrication chamber and encompass the component chain, cable, belt, rope or line. The ‘snap-fit’ locking feature that can be molded or cast into the closure ‘flap or tab’ or provide for the insertion and retention of a pre-manufactured ‘snap-fit’ device, or other equivalent fastening mechanism. This ‘snap-fit’ is created by the insertion of a ‘snap-fit’ pin into a ‘receptor’ hole which has been created in the lower half of the ‘clam shell’ section of the tool; this aperture is of a diameter such that the locking ‘pin’ can be inserted and removed easily, yet provides adequate resistance so that the locking function of the closure mechanism will not loosen or separate under normal use and will be of sufficient resistance so that opening and closing the closure mechanism can be done by hand with minimal effort. The ‘flap or tab’ latch provides a ‘handle or lever’ of sufficient surface area in which to lift and open the closure mechanism and to apply pressure to insert the ‘snap-fit’ pin locking device into the ‘receptor’ hole to close and lock the tool by hand and with minimal effort.

As a process of the molding or casting process, the tool body is created which integrates portal attachment features 904 that provide for and create an insertion or coupling point for removable tube conduits, These integral portal or coupler features are designed in such a way that an external portal and ‘slip-fit’ coupler feature is realized for both the dispensing portal and the drain portal.

Integral to the design, Apertures are disposed that provide unrestricted flow into and flow out of the interior chamber of the tool by way of the delivery tubing, and the drain tubing. These portal features are of sufficient shape and size so as to facilitate a ‘nozzle’ disposed in the top section of the ‘clam shell’ so materials entering the chamber can be widely dispersed within the device interior. A ‘sump’ drain of sufficient shape and size is created in the bottom section of the ‘clam shell’ to facilitate a way for excess materials to be evacuated/drained effectively. The diameter of the aperture is such that a length of conduit tubing can be inserted by hand in a ‘slip-fit’ manner, with sufficient compression, resistance, or friction present in order to retain the tubing in place during the normal use of the tool and subsequently allow for easy and repeatable insertion and removal of these tubing segments in order to facilitate all manner of lengths of tubing, attachment of the tool to the component chain, cable, belt, rope or line and/or storage of the tool components. Of note: the shell may be designed with sufficient interior room so that the tubing and the like may be stored inside of the shell, when not in use.

The interior of the molded or cast body may include integrally formed applicators, brushes, dams or the like 903 that protrude into the cavity in such a way that these applicators make contact with the component, and are of sufficient number to accomplish the dispersion and control of fluid flow from the dispersion portal ‘nozzle’ orifice, and constrict outflow of material from the tool openings at the end of the body, and direct excess materials towards the evacuation port, or ‘sump’ aperture. These integrally formed protruding applicators can be strategically oriented and of shape, size, resiliency, subtleness or flexibility, such that effective dispersement and constraint of lubricant entering the tool may be achieved, while allowing the component chain, cable, belt, rope or line to flow through the tool without restriction during lubrication or dressing.

Tubing segments may be cut to suitable length 912 and are of adequate interior and exterior dimension so to provide convenient access by the user of the tool, to the exposed end of the delivery tubing, for the attachment of the syringe mechanism and alternatively for coupling to an aerosol spray-can's nozzle extension tubes. This multifunction interface port at the end of the tubing distal from the tool is constructed by attaching a prefabricated luer-locking coupler to the exposed end of the delivery tubing, so that the syringe mechanism can lock onto the end by means of a ‘twist-lock/luer-lock’ connection 914. Or if the exterior diameter of the tubing is sufficient to facilitate the syringe mechanism to couple in such a way that the threads of the luer-lock grip and lock onto the tubing so to create a durable connect/disconnect coupling point onto the tubing. This can be accomplished by using tubing with adequate interior and exterior dimensions in which this coupling can be realized or by building up the diameter of a smaller diameter tube by techniques known to those skilled in the art, to provide the appropriate grip for the luer-lock threads of the syringe coupler mechanism. Alternatively, male-female luer-lock components or their equivalents may be used. This coupling point at the end of the tube distal from the body is also capable of accepting the small diameter extension tubing commonly found on aerosol spray cans, by inserting this small extension tube into the delivery tubing at the loose end.

The syringe mechanism may be fabricated from a pre-manufactured syringe made of suitable material that is impervious to degradation from lubrication fluids, and includes a locking mechanism that allow the syringe to be coupled/mated by means of a luer-locking mechanism. The physical dimensions and capacity of the syringe mechanism must be of relative size and proportion so the pumping action of the syringe efficiently conveys fluid material of sufficient quantity to accomplish controlled and continuous flow of material into the chamber formed by the closed tool.

A stabilization leash is fashioned by strategically attaching one end of a line or cord of suitable material to the tool body. It may be secured by tying, wrapping, fastening by other equivalent methods and is typically long and flexible enough to allow the other end of the leash to be subsequently secured to the machine structure. Accordingly that the tool can be strategically and securely positioned to allow for stable hands-free use of the tool without interference to the rest of the parent machine mechanism in which the chain, cable, belt, rope or line is employed and the tool cannot be dragged into the mechanism by frictional forces created by contact to the chain, cable, belt, rope or line component.

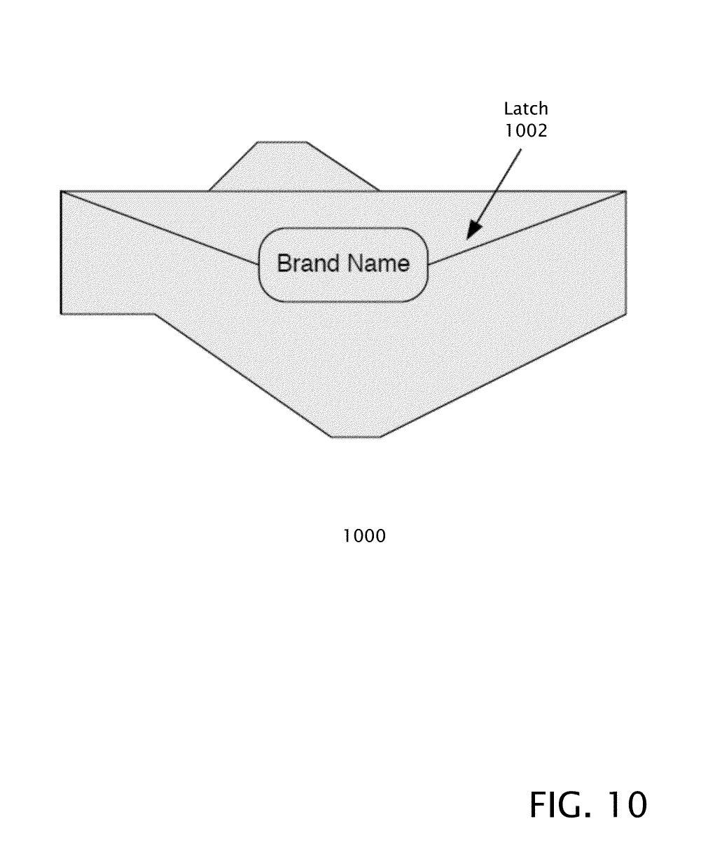

FIG. 10 shows a front view of an alternative example of the invention 1000. This example of the invention incorporates a hinged substantially flat lid or top over a rectangular shaped “U” housing or shield, with the delivery tubing (not shown) being attached with the features as previously shown, this example can have forms that reduce the amount of material needed to create the feature or joining orifice receptor points. The housing is formed a box (or equivalent shaped cavity for the purposes described herein) with a somewhat flat lid that is retained with the same snap-lock mechanism 1002 as previously described, including in alternative examples, a magnetic latch.

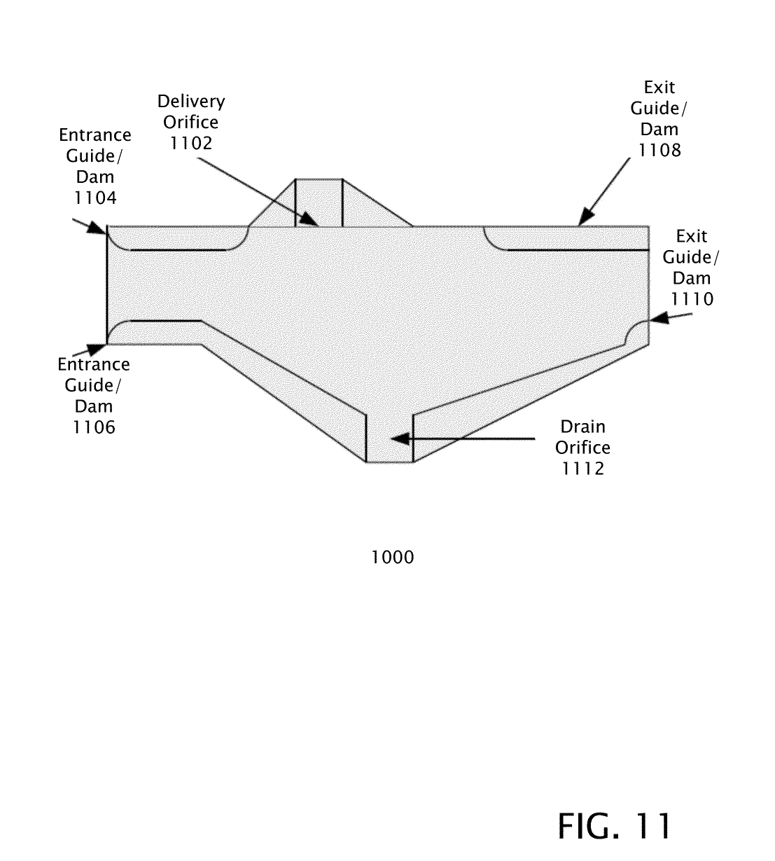

FIG. 11 shows a cut away side view of the alternative example of the invention 1000. The delivery orifice 1102 and drain orifice 1112 are constructed as previously described, however they are offset here, so that delivery of lubricant is closer to where the part enters the tool 1000. Entrance guides, or dams 1104, 1106 are provided to guide the component into the tool 1000, and to prevent lubricant from escaping. Similarly constructed are the exit guides or dams 1108, 1110.

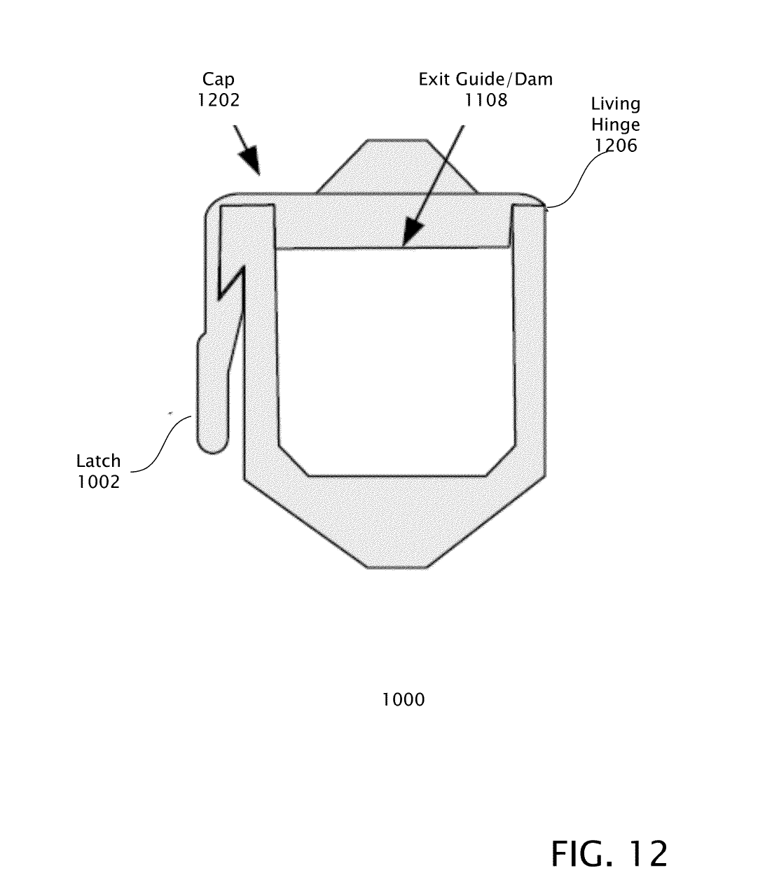

FIG. 12 shows a cut away end view of the alternative example of the invention 1000 The end view show the upper guide or dam 1108, disposed in the cap 1202. The cap couples to the body through a living hinge 1206, that is constructed as previously described from thinned material. The latch 1002 includes a protrusion that engages a lip disposed in the housing. The flexible nature of the material allows the latch to engage and disengage the material.

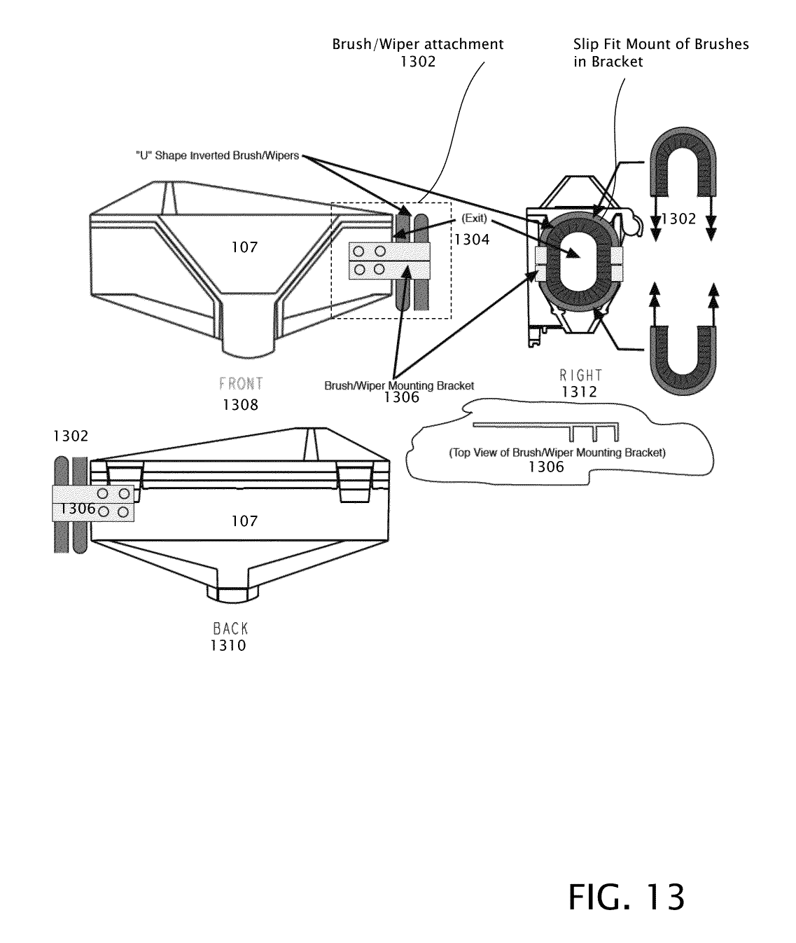

FIG. 13 shows a brush/wiper attachment 1302 coupled to the tool body 107. Such a brush/wiper tool may be coupled to the previously described tool to further remove excess, or more evenly distribute lubricant over the chain (not shown) exiting 1304 the tool. The example below is exemplary as a number of other brush configurations and their attachment are contemplated for providing a brush at the tool exit. The example shown advantageously provides two sets of brackets (alternatively the set of brackets could be a single piece) and four “U” shaped brushes, fitting into the brackets by way of an interference fit. The brushes are removably coupled to the bracket(s) 1306.

The “Front” 1308 View shows the Brush/Wiper Mounting Bracket 1306 with brushes affixed or coupled to the “Exit” side of the body of the tool where the Mounting Bracket can be mechanically attached or formed, or equivalent provided as part of the body of the tool as a seperable single piece or multi-piece element. Equivalently the bracket may be molded as part of the tool. The shape of the bracket is shown as being “E” shaped with a leg. When the brackets are coupled to the tool, with the open sides of the f facing each other, “U” shaped wipers or brushed may be inserted in parallel to each other, by inserting the legs of the “U” shaped brushes into the two channels or groves formed.

The “Front” View shows the “U” shape Inverted Brush/Wipers independently inserted and oriented into the Mounting Bracket by typically utilizing a “slip-fit”, where the legs of the typically U-shaped brushes slip into a mating receptacle, in order to facilitate easy installation and removal of the Brush/Wiper.

The “Back” 1310 View shows the details from the back-side view and the back-side Mounting Bracket, which are substantially the same as described for the front view

The “Right” View or “Exit” View 1312 shows the orientation of two “U” shape Brush/Wipers creating a 360° Brush/Wiper action at the exit of the tool body and the direction in which the Brush/Wipers are installed and removed from the Mounting Bracket.

A function of the Brush/Wiper attachment is to act as a dam/wiper at the exit of the tool to reduce or eliminated watery liquids, like cleaning solvents from dipping on to the floor or other surfaces and reducing the amount of preparation for cleaning and subsequent clean-up of any material that may not have been contained. The secondary purpose of the Brush/Wiper attachment is the facilitation of a wider distribution of lubricants onto the chain or element and the wiping and brushing-off residual dirt and build-up from the chain or whatever element is passing through the tool, and out the end.

The “slip-fit” mounting design allows for easy installation and removal of the tool and easy installation and removal of the Brush/Wipers. Because of this unique mounting system the Brush/Wipers can be replaced when worn and stored when they are not needed, as might occur during routine lubricating sessions where the Brush/Wiper serves little function generally. When two opposing “U” shaped Brush/Wipers are installed, their combined orientations creates a 360° Brush/Wiper action that encompasses all facets of the exterior of a chain for example.

In summary, the Brush/Wiper attachment typically serves to provide better retention of watery liquid cleaners and solvents that may leak from the exit of the tool as well as a way to more widely distribute lubricants and cleaners over the surface of a chain, belt, line, cable, rope, etc, and provide some brushing-off of dirt and residues.

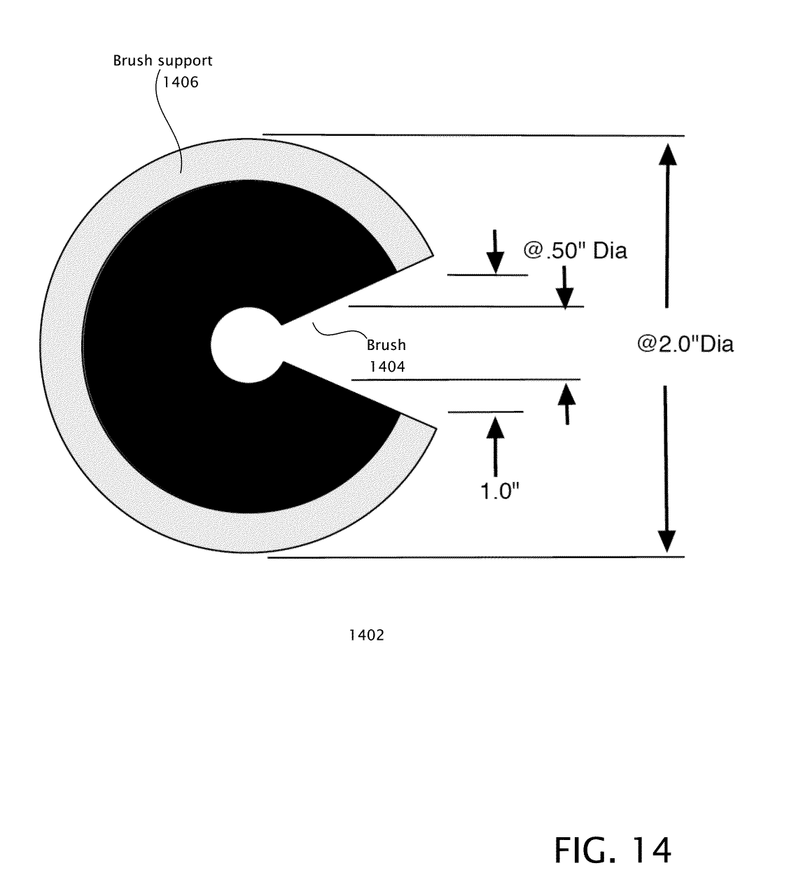

FIG. 14 shows an alternative example 1402 of a brush/wiper (1302 of FIG. 13). Alternatively a spiral brush, or a circular brush or its equivalent could be coupled to the exit orifice of the tool with a suitable bracket or point of attachment. The dimensions shown in the figure are exemplary, and not limiting A circular brush, or equivalent, might advantageously have a cut, split or opening in its circumference so that the chain could pass to the interior of the brush. The brush bristles 1404 may be of any suitable material that is solvent resistant and provides other desired qualities, such as stiffness or the like. In further alternative examples pads, or other wiping structures may equivalently be substituted for bristles. The material that forms the supporting base of the brush 1406 may be any convenient material that secures the bristles, and that may provide a degree of flexibility or springy ness to hold is shape when inserted into the bracket. The brackets may be formed from any convenient number of parts, and may be mad of any suitable material. The brackets may be removabaly coupled, or fixedly coupled to the tool. Coupling may be aided by an interference fit, rivets, screws, or the like.

Those skilled in the art will realize that the process sequences described above may be equivalently performed in any order to achieve a desired result. Also, sub-processes may typically be omitted as desired without taking away from the overall functionality of the processes described above.

1. A lubricating device constructed to enclose a section of a work piece such that it may slidebally pass through the lubricating device comprising:
a body capable of being opened;
a delivery tube coupled to the body at a coupling port on the body for delivering a liquid to the work piece as it passes through the body;
a drain tube coupled to the body at a coupling port for collecting the excess liquid not adhering to the work piece; and
a removable brush assembly coupled to the body at a work piece exit.

2. The lubricating device of claim 1, further comprising an anchoring device coupled to the body, whereby the lubricating device may be anchored allowing the work piece to pass through it.

3. The lubricating device of claim 1, further comprising applicators operably coupled to the body for applying the liquid to the work piece.

4. The lubricating device of claim 3, in which the applicators are wipers.

5. The lubricating device of claim 3, in which the applicators are pads.

6. The lubricating device of claim 1, further comprising a syringe pump mechanism coupled to the delivery tube with a coupling.

7. The lubricating device of claim 1, in which the delivery tube and the drain tube are disposed in cavities in the body.

8. The lubricating device of claim 1, in which the body further comprises:
a snap fit latch; and a hinge.

9. The lubricating device of claim 1, in which the body is made from high density polyethylene.

10. The lubricating device of claim 1, in which the work piece is a drive chain.

11. A drive chain lubricating system comprising:
a syringe containing a lubricant;
a delivery tube having a first end and a second end, the first end coupled to the syringe;
a tool body having a port for accepting the second end of the delivery tube, an entry port for the drive chain, and an exit port for the drive chain, so that the drive chain may pass through the tool body as lubricant is applied along the length of the drive chain passing through the tool body.

12. The lubricating system of claim 11 in which the tool body further comprises a drain port.

13. The lubricating system of claim 13 further comprising:
a drain tube having a first end coupled to the drain port.

14. A process for forming lubricating device comprising:
forming a body having an integral latch, and flexible hinge point, with apertures at opposite ends;
forming at least one slip fit coupler port in the body.
coupling a tube to the slip fit coupler port; and
disposing applicators in the body.
